(19) United States
(12) Patent Application Publication
(10) Pub. No.: US 2025/0079958 A1
(43) Pub. Date: Mar. 6, 2025

(54) Electric Propulsion Engine

(71) Applicant: All Aligned Consulting LLC, Hermosa Beach, CA (US)

(72) Inventor: Jack Levy, Hermosa Beach, CA (US)

(21) Appl. No.: 18/827,482

(22) Filed: Sep. 6, 2024

Related U.S. Application Data
(60) Provisional application No. 63/580,975, filed on Sep. 6, 2023.

(51) Int. Cl. H02K 16/02; H02K 7/09

(52) U.S. Cl. CPC H02K 16/02; H02K 7/09

(57) ABSTRACT

According to various implementations of the invention, an electric propulsion engine includes: an engine housing forming an outer stator chamber and an inner rotor chamber, the outer stator chamber surrounding and concentric with the inner rotor chamber, the inner rotor chamber having an intake opening and an exhaust opening; an electromagnetic stator configured within the outer stator chamber; a plurality of rotors disposed within the inner rotor chamber along a central axis of the inner rotor chamber, each of the plurality of rotors having a plurality of rotor blades configured to rotate around the central axis of the inner rotor chamber thereby compressing a fluid as the fluid passes from the intake opening of the inner rotor chamber toward the exhaust opening of the inner rotor chamber, each of the plurality of rotor blades having a magnetic rotor blade edge responsive to the electromagnetic stator; and an engine controller configured to provide a control signal to the electromagnetic stator to cause the plurality of rotor blades of at least a portion of the plurality of rotors to rotate around the central axis of the inner rotor chamber thereby producing thrust from the flow of the fluid from the intake opening of the inner rotor chamber toward the exhaust opening of the inner rotor chamber.

### CROSS-REFERENCE TO RELATED APPLICATIONS

This application claims priority to U.S. Provisional Application No. 63/580,975, filed on Sep. 6, 2023, which is incorporated herein by reference in its entirety.

### BACKGROUND OF THE INVENTION

Electric motors convert electrical energy into magnetic fields to facilitate mechanical work, via the production of torque. An electric motor typically includes a stator and rotor. The stator is typically stationary and produces magnetic field(s) and the rotor turns in relation to the stator in response to the magnetic fields. The stator and the rotor usually are separated by a small airgap that is close enough for the magnetic fields to create mechanical work but far enough apart to allow the rotor to rotate freely, even in alternating directions. In this way, electric power may be fed into the stator, thereby creating the magnetic fields, and while mechanical power may be extracted from the rotor as it rotates.

The rotor is often formed with permanent magnetic materials (e.g., on the outer part of the rotor, within its interior, etc.) that become either magnetically attracted or repulsed in response to magnetic fields produced by the stator. Higher amounts of current flowing through the stator will typically generate larger magnetic fields, whereas lessor amounts of current will typically generate smaller magnetic fields. Power can be transferred over the airgap by the magnetic flux density, creating a torque that acts on the rotor. A torque in the opposite direction may also act on the stator.

Various designs of electric motors have been adapted to propel wheel-based vehicles (e.g., cars or trucks). However, most ideas for propelling vehicles for air travel either utilize electric motors to drive propellers or as a hybrid assist to a petroleum-based engine. Electric driven propellers are limited in the amount of thrust they can generate, making them suitable for drone aircraft and light passenger aircraft, but not much more. There remains a need in the air transportation industry to provide a viable and efficient electric propulsion engine for air travel.

### SUMMARY OF THE INVENTION

According to various implementations of the invention, an electric propulsion engine includes: an engine housing forming an outer stator chamber and an inner rotor chamber, the outer stator chamber surrounding and concentric with the inner rotor chamber, the inner rotor chamber having an intake opening and an exhaust opening; an electromagnetic stator configured within the outer stator chamber; a plurality of rotors disposed within the inner rotor chamber along a central axis of the inner rotor chamber, each of the plurality of rotors having a plurality of rotor blades configured to rotate around the central axis of the inner rotor chamber thereby compressing a fluid as the fluid passes from the intake opening of the inner rotor chamber toward the exhaust opening of the inner rotor chamber, each of the plurality of rotor blades having a magnetic rotor blade edge responsive to the electromagnetic stator; and an engine controller configured to provide a control signal to the electromagnetic stator to cause the plurality of rotor blades of at least a portion of the plurality of rotors to rotate around the central axis of the inner rotor chamber thereby producing thrust from the flow of the fluid from the intake opening of the inner rotor chamber toward the exhaust opening of the inner rotor chamber.

In some implementations of the invention, the engine housing forms the inner rotor chamber so that the inner rotor chamber tapers downward from the intake opening to the exhaust opening.

In some implementations of the invention, the electric propulsion engine of further includes an induction heater concentric with the central axis of the inner rotor chamber configured to provide additional heat to the fluid flowing through inner rotor chamber, thereby increasing thrust of the electric propulsion engine. In some implementations of the invention, the induction heater is disposed proximate to the exhaust opening of the inner rotor chamber. In some implementations of the invention, the induction heater includes: a hollow metal core configured to be concentric with the central axis of the inner rotor chamber; a temperature resistance non-magnetic shield configured to outwardly surround the hollow metal core; and a copper coil configured to outwardly surround the shield, wherein the copper coil is further configured to generate eddy currents in the metal core, thereby heating the metal core, thereby further heating the fluid that flows through the induction heater. In some implementations of the invention, the hollow metal core comprises a hollow copper or copper alloy core or other material that generates heat from eddy currents.

In some implementations of the invention, the electric propulsion engine further includes: a shaft located along and concentric with the central axis on the inner rotor chamber; and a plurality of bearings disposed along the shaft, wherein each of the plurality of bearings is configured to rotatably couple one of the plurality of rotors to the shaft. In some implementations of the invention, each of the plurality of rotors further comprises a rotor housing. In some implementations of the invention, the plurality of the rotor blades are fixed to the rotor housing, where the rotor housing is fixed to a plurality of spokes that collectively couple the rotor housing to one of the plurality of bearings.

In some implementations of the invention, each of the plurality of rotors further comprises a rotor housing, where the rotor housing is configured to mount to the engine housing within the inner rotor chamber, where the rotor blades of the rotor are configured to rotate within and relative to the rotor housing and around the central axis of the inner rotor chamber.

In some implementations of the invention, each of the plurality of rotors and its respective plurality of rotor blades forms an impeller.

In some implementations of the invention, each of the plurality of rotors and its respective plurality of rotor blades forms a turbine.

In some implementations of the invention, the engine controller provides control signals to a plurality of electromagnetic stators, each of which causes a corresponding one of the plurality of rotors to rotate around the central axis of the inner rotor chamber.

In some implementations of the invention, the engine controller provides controls signals that cause some of the plurality of rotors to rotate at different angular rates than others of the plurality of rotors.

In some implementations of the invention, the engine controller provides controls signals that cause some of the plurality of rotors to rotate in different directions than others of the plurality of rotors.

In some implementations of the invention, the electric propulsion engine further includes: a shaft to which each of the plurality of rotors is affixed; and at least one magnetic bearing on which the shaft rotates, thereby rotating each of the plurality of rotors.

In some implementations of the invention, the electric propulsion engine further incudes: a shaft; and a plurality of magnetic bearings, each of the plurality of magnetic bearings rotatably affixed between the shaft and a corresponding one of the plurality of rotors upon which the corresponding one of the plurality of rotors rotates, whereby each of the plurality of rotors rotates independently from the shaft and from each other.

In some implementations of the invention, the electric propulsion engine further incudes: a plurality of magnetic bearings, each of the plurality of magnetic bearings rotatably affixed between a rotor housing associated with each of the plurality of rotors and the plurality of rotor blades upon which the plurality of rotor blades rotate within the rotor housing.

According to various implementations of the invention, an electric propulsion engine includes: an engine housing forming an inner rotor chamber, the inner rotor chamber having an intake opening and an exhaust opening; an electromagnetic stator configured around an exterior of the engine housing; a plurality of rotors disposed within the inner rotor chamber along a central axis of the inner rotor chamber, each of the plurality of rotors having a plurality of rotor blades configured to rotate around the central axis of the inner rotor chamber thereby compressing a fluid as the fluid passes from the intake opening of the inner rotor chamber toward the exhaust opening of the inner rotor chamber, each of the plurality of rotor blades having a magnetic rotor blade edge responsive to the electromagnetic stator; and an engine controller configured to provide a control signal to the electromagnetic stator to cause the plurality of rotor blades of at least a portion of the plurality of rotors to rotate around the central axis of the inner rotor chamber thereby producing thrust from the flow of the fluid from the intake opening of the inner rotor chamber toward the exhaust opening of the inner rotor chamber.

These and other features and implementations of the invention are described in detail below.

### BRIEF DESCRIPTION OF THE DRAWINGS

FIGS. 1A, 1B and 1C illustrate an electric propulsion engine from various perspectives in accordance with various implementations of the invention.

FIG. 2 illustrates an exploded view of an electric propulsion engine including various components in accordance with various implementations of the invention.

FIG. 3 illustrates a cross-sectional view of an electric propulsion engine including various components in accordance with various implementations of the invention.

FIG. 4 illustrates a rotor of an electric propulsion engine in accordance with various implementations of the invention.

FIG. 5 illustrates an induction heater of an electric propulsion engine in accordance with various implementations of the invention.

FIG. 6 illustrates a cross-sectional view of an electric propulsion engine with an induction heater in accordance with various implementations of the invention.

FIG. 7 illustrates an exploded view of a magnetic bearing in accordance with various implementations of the invention.

### DETAILED DESCRIPTION

Various implementations of the invention are now described in reference to the drawings mentioned above. While an electric propulsion engine in accordance with various implementations is described in reference to air travel, such an engine may be used with fluids other than air, such as, but not limited to water.

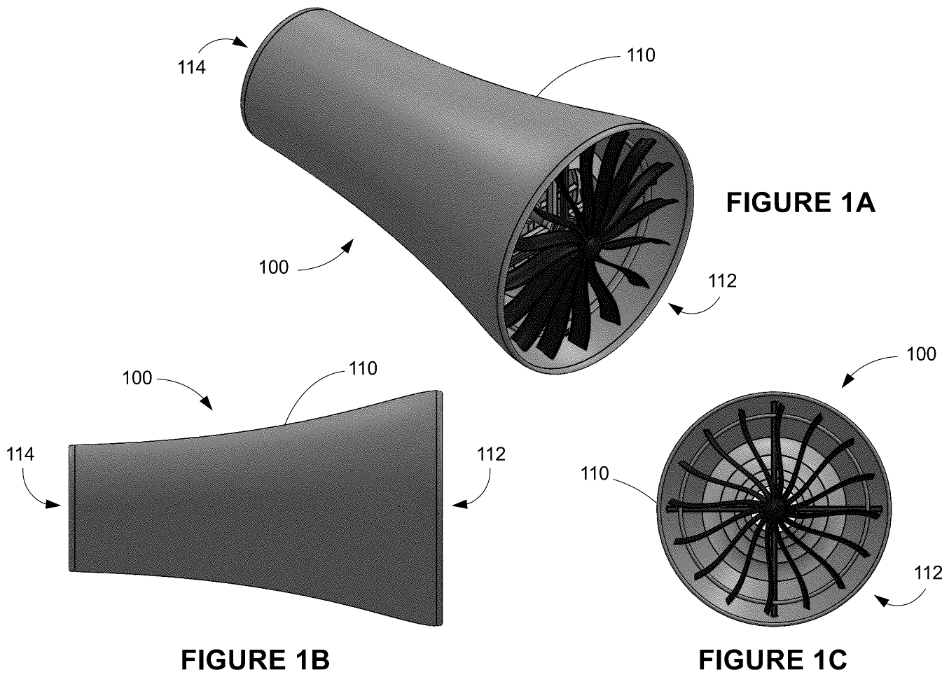

FIGS. 1A, 1B and 1C illustrate an electric propulsion engine 100 from various perspectives in accordance with various implementations of the invention. FIG. 1A illustrates a three-dimensional perspective view of electric propulsion engine 100 including an engine housing 110 having an intake opening 112 and an exhaust opening 114. FIG. 1B illustrates a side view of electric propulsion engine 100. FIG. 1C illustrates a front view of electric propulsion engine 100 peering into electric propulsion engine 100 from intake opening 112.

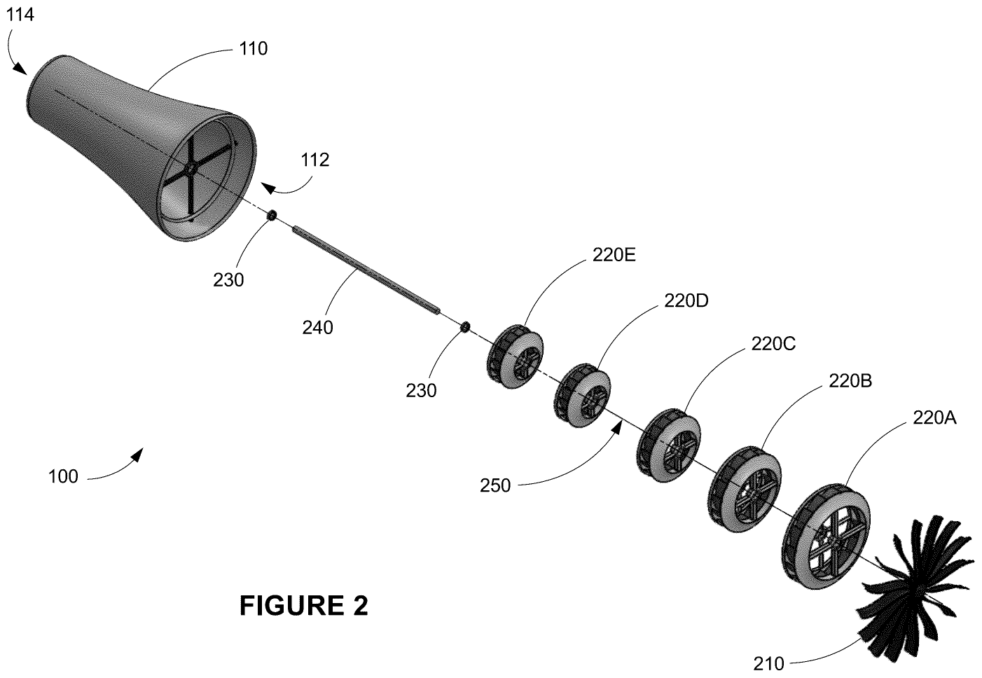

FIG. 2 illustrates an exploded view of electric propulsion engine 100 including various components in accordance with various implementations of the invention. As illustrated in FIG. 2, in various implementations of the invention, electric propulsion engine 100 includes engine housing 110 and may further include a fan 210, a plurality of rotors 220 (illustrated in FIG. 2 as a rotor 220A, a rotor 220B, a rotor 220C, a rotor 220D, a rotor 220E, etc.), a shaft 240, and one or more bearings 230. These components of electric propulsion engine 100 are disposed within an interior of engine housing 110 along a central axis 250 of engine housing 110.

As illustrated in FIG. 2 (and elsewhere), engine housing 110 tapers downwardly from intake opening 112 toward exhaust opening 114. In other words and generally speaking, a radius of engine housing 110 at intake opening 112 is greater than a radius of engine housing 110 at exhaust opening 114. As would be appreciated, such a taper provides for increased pressure of a fluid that flows through engine housing 110 from intake opening 112 toward exhaust opening 114. A taper of engine housing 110 may be linear or non-linear (as illustrated). As illustrated in FIG. 2, the taper of engine housing 110 is substantially decreasing from intake opening 112 toward exhaust opening 114, although other shapes and combinations of decreasing and/or increasing tapers, including no taper at all, may be used as would be appreciated. Accordingly, a radius of each of the plurality of rotors 220 may be adjusted to fit within engine housing 110 at its respective location along central axis 250 as would be appreciated.

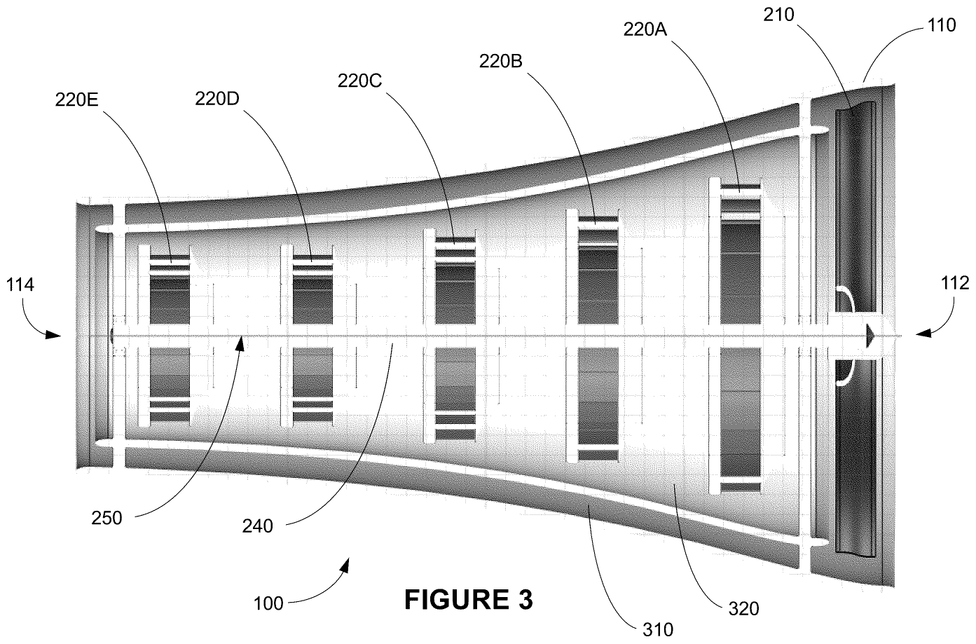

FIG. 3 illustrates a cross-sectional view of electric propulsion engine 100 including engine housing 110 and rotors 220 in accordance with various implementations of the invention. As illustrated in FIG. 3, engine housing 110 tapers downwardly from intake opening 112 to exhaust opening 114. In some implementations of the invention, engine housing 110 forms two different interior chambers, namely, a stator chamber 310 and a rotor chamber 320; in some implementations of the invention, engine housing 110 forms one interior chamber, namely, rotor chamber 320. Stator chamber 310 extends circumferentially around and substantially concentrically with rotor chamber 320 (i.e., around central axis 250). In some implementations of the invention, stators (not otherwise illustrated) are disposed within stator chamber 310 of engine housing 110. In some implementations of the invention, stators are disposed around an exterior of engine housing 110. A stator typically comprises electromagnetic winding(s) and core(s) that are driven by current to cause, via electromagnetic fields, corresponding rotor(s) to rotate in accordance with conventional electric motor principles as would be readily appreciated. As would be appreciated, stator(s) disposed with stator chamber 310 may collectively drive rotors 220, or individual stators may drive individual rotors 220. As would also be appreciated, a controller (not otherwise illustrated) may provide drive signals (e.g., current signals) to the stators in order to produce various drive profiles for rotors 220.

In some implementations of the invention, stators may be cooled by a coolant flowing through stator chamber 310 or around an exterior of engine housing 110 as would be appreciated. In some implementations of the invention, this coolant may flow in a direction from intake opening 112 to exhaust opening 114 in order to provide additional heat to the fluid flowing through rotor chamber 320, and then subsequently recycled back as would be appreciated.

FIG. 3 illustrates a plurality of rotors 220 (e.g., rotors 220A-220E) disposed along shaft 240 along central axis 250 within rotor chamber 320. In some implementations of the invention, rotor 220A located nearest intake opening 112 has a greater radius than the other rotors 220B-220E. Likewise, rotor 220B located next along shaft 240 has a radius less than rotor 220A and greater than the remaining rotors 220C-220E. Similarly, rotor 220C located next along shaft 240 has a radius less than rotor 220A and rotor 220B, and greater than the remaining rotors 220D-220E. In some implementations of the invention, the radii of rotors 220 is determined based on a radius of rotor chamber 320. In some implementations, the radii of rotors 220 may be the same as one another as would be appreciated. In some implementations, some of the radii of rotors 220 may be the same as one another, and some of the radii may differ from one another as would be appreciated. The differences in the radii of rotors 220 may be determined to adjust a desired thrust output of electric propulsion engine 100 as would be appreciated.

In some implementations of the invention, a fan 210 is located at or near intake opening 112, where fan 210 mildly compresses the otherwise uncompressed fluid entering engine housing 110 at intake opening 112. In some implementations of the invention, fan 210 is disposed on shaft 240, though in other implementations of the invention, fan 210 may be disposed on a shaft separate from shaft 240 (i.e., a shaft different from shaft 240 on which rotors 220 are disposed) as would be appreciated.

In operation, rotors 220 drive a fluid (e.g., air, liquid, etc.) through rotor chamber 320 from intake opening 112 toward exhaust opening 114. Each rotor 220, in cooperation with walls of rotor chamber 320 of engine housing 110, serves to compress the fluid from an intake side (i.e., side nearest intake opening 112) to an exhaust side (i.e., side nearest exhaust opening 114) as would be appreciated. Each rotor 220 increases an overall compression of the fluid in stages from intake side to exhaust side, until exhaust opening 114 is reached, at which point, the compressed fluid rapidly expands (i.e., decompresses) creating a propulsive thrust from electric propulsion engine 100.

In some implementations of the invention, in addition to compressing the fluid through various stages of rotor chamber 320, each rotor 220 may also provide some degree of cooling to stator chamber 310 as would be appreciated.

In some implementations of the invention, when rotors 220 are fixed to shaft 240, all rotors 220 rotate at a same angular rate and direction as shaft 240. In some implementations of the invention, when rotors 220 are rotatably fixed to shaft (i.e., fixed on a bearing on shaft 240 such that rotor 220 rotates independently from the shaft and potentially independently from each other), each rotor 220 may rotate at a different angular rate and/or a different direction from one another to provide varying and/or different compression profiles throughout rotor chamber 320, and thus, differing propulsion profiles. In some implementations of the invention, when rotors 220 are fixed to engine housing 110 (i.e., a wall of engine housing 110 that forms rotor chamber 320) instead of shaft 240 (in which case, shaft 240 may not be necessary), rotors 220 may also rotate at different angular rates and/or different directions from one another to provide varying and/or different compression profiles throughout rotor chamber 320, and thus, differing propulsion profiles.

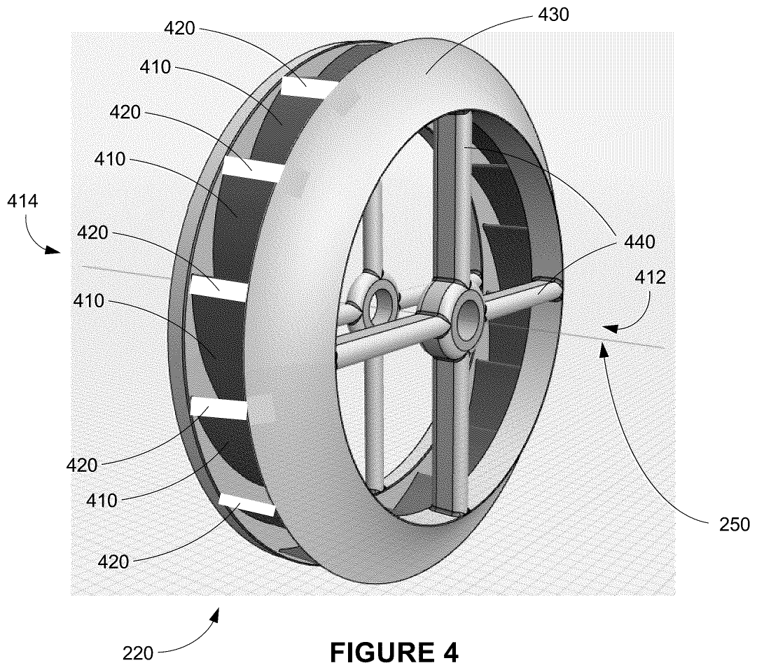

FIG. 4 illustrates rotor 220 of electric propulsion engine 100 in accordance with various implementations of the invention. Rotor 220 comprises a rotor housing 430 and a plurality of rotor blades 410 (solely for ease of illustration, not all rotor blades in FIG. 4 are supplied with a “410” designation). In some implementations of the invention, rotor blades 410 are fixed to rotor housing 430. In such implementations of the invention, rotor housing 430 and rotor blade 410 rotate together around central axis 250. In some implementations of the invention, rotor housing 430 may be coupled to shaft 240 via a plurality of spokes 440. In some implementations of the invention, spokes 440 are fixed to shaft 240 such that spokes 440, rotor housing 430, and rotor blades 410 rotate with shaft 240. In some implementations of the invention, spokes 440 are fixed to a bearing on shaft 240 (not illustrated in FIG. 4) such that spokes 440, rotor housing 430, and rotor blades 410 rotate independently from shaft 240.

In some implementations of the invention, rotor blades 410 are rotatably fixed within rotor housing 430 such that rotor blades rotate within and independently from rotor housing 430 via a bearing mounted in rotor housing 430 (not otherwise illustrated). In such implementations of the invention, only rotor blades 410 rotate around central axis 250, while rotor housing 430 remains fixed (e.g., to the wall of engine housing 110 that forms rotor chamber 320). In such implementations, shaft 240 may not be necessary. In any case, rotor 220 with its rotor blades 410 may be configured as a turbine or as an impeller, or the like, to compress the fluid from an intake side 412 to an exhaust side 414 as would be appreciated. A configuration, a shape, a length, a width, a thickness, a twist, an orientation, etc., of each rotor blade 410, and a number of rotor blades 410 within rotor 220, as well as other factors, effect an amount and nature of compression of the fluid that occurs as would be appreciated.

In accordance with various implementations of the invention, each rotor blade 410 includes a magnetic portion 420 formed of a magnetic material suitably selected to interact with the electromagnetic stators described above to cause rotor blades 410 to rotate. In some implementations of the invention as illustrated in FIG. 4, magnetic portion 410 is located at an outer edge of each rotor blade 410 thereby forming a magnetic rotor blade edge. In some implementations of the invention, a significant portion of each rotor blade 410 is formed of the magnetic material. In some implementations of the invention, each rotor blade 410 itself is formed of the magnetic material. In some implementations of the invention, magnetic portions 420 are located around rotor housing 430 rather than on rotor blades 410 (not otherwise illustrated); in such implementations, rotor housing 430 rotates with rotor blades 410 fixed thereto within rotor chamber 320. In some implementations of the invention, magnetic portions 420 are located on each rotor blade 410 (or around rotor housing 430) in a manner that optimizes a balance of torque and efficiency of rotor 220 as would be appreciated.

By adapting a conventional rotor of an electric motor as rotor 220 with rotor blades 410 each with a magnetic portion 420, each rotor 220 becomes a turbine or impeller capable of generating thrust for electric propulsion engine 100, and facilitates reliance on electric energy rather than fuel and combustion.

In general, forced compression of fluid in the manner described above should generate less heat than conventional combustion-based jet engines. However, a composition of various components of the invention should be heat tolerant materials. In some implementations of the invention, such heat tolerant materials may also be non-metallic materials where possible so as to not interfere with conductive and/or magnetic components of the invention as would be appreciated. In some implementations of the invention, magnetic materials selected for various magnetic components should likewise be somewhat heat tolerant so as to not degrade in performance over operational conditions and/or time as would be appreciated.

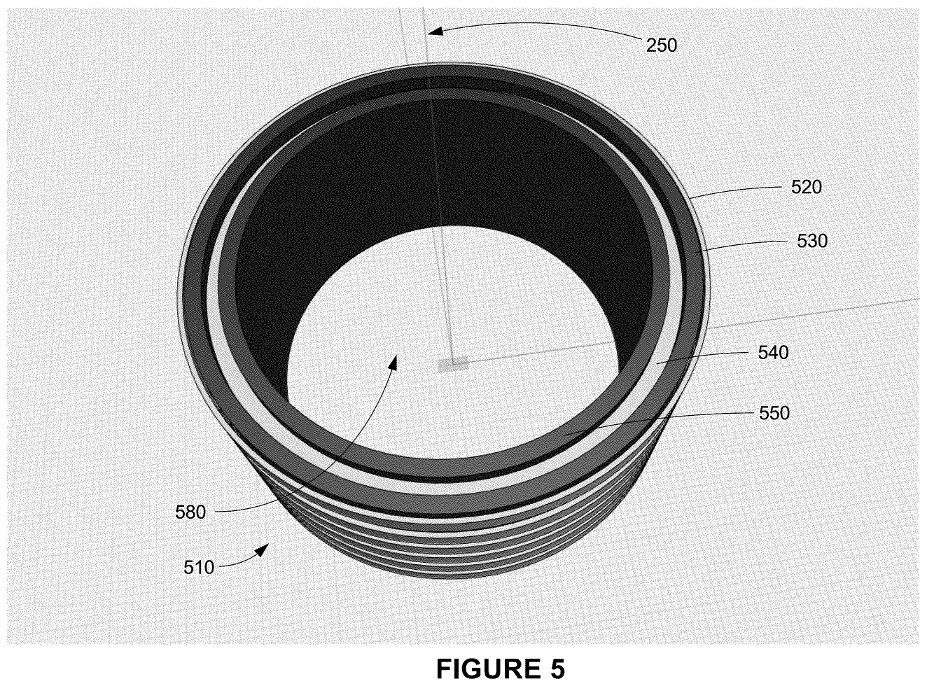

FIG. 5 illustrates an induction heater 510 that may be used with electric propulsion engine 100 in accordance with various implementations of the invention. Once the fluid is compressed by the plurality of rotors 220, additional pressure may be created within the fluid by heating it via induction heater 510. In various implementations of the invention, induction heater 510 includes a hollow inner metal core 540, a temperature resistance non-magnetic shield 530 surrounding inner metal core 540, and a copper coil 520 surrounding shield 530. In various implementations of the invention, inner metal core 540, shield 530, and copper coil 520 of induction heater 510 are concentrically disposed with regard to one another. In some implementations of the invention, inner metal core 540, shield 530, and copper coil 520 of induction heater 510 are concentrically disposed around central axis 250 as would appreciated. In some implementations of the invention, inner metal core 540 is formed from copper or a copper alloy. In some implementations of the invention, copper coil 520 is formed as a hollow copper tube configured to transport coolant through copper coil 520 for purposes of cooling copper coil 520.

When current is applied to copper coil 520, eddy currents are generated in inner metal core 540, thereby generating heat within inner metal core 540 as well as an interior 580 formed by inner metal core 540, and further, heating any fluid passing through interior 580 as would be appreciated. Heat applied to the fluid by induction heater 510 further accelerates and expands the compressed fluid, causing the fluid to exit through exhaust opening 114 with increased velocity, and hence, providing additional propulsion from electric propulsion engine 600.

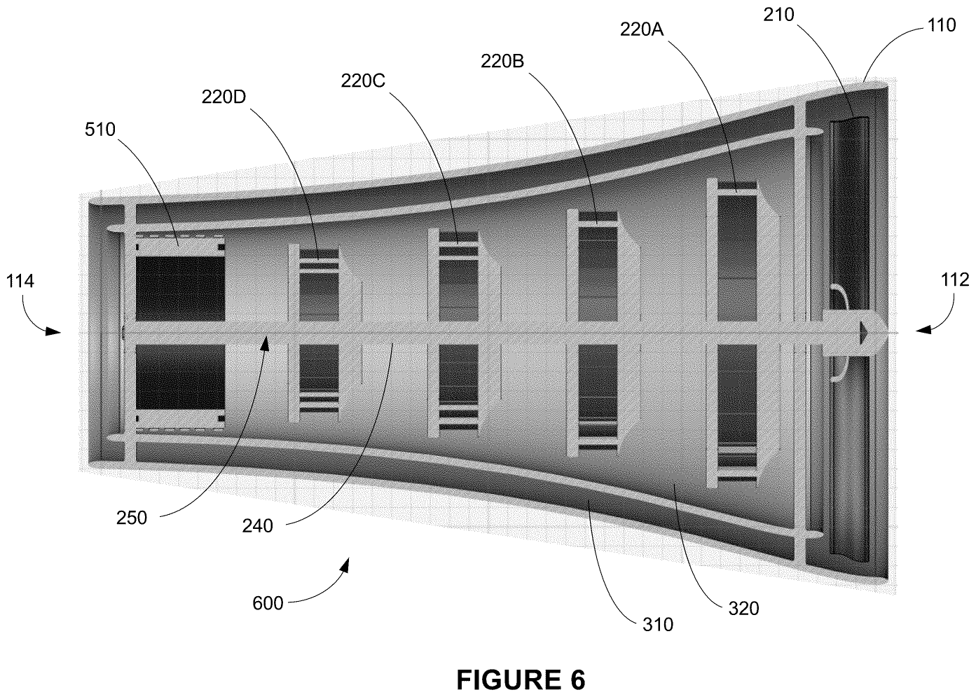

FIG. 6 illustrates a cross-sectional view of an electric propulsion engine 600 with induction heater 510 disposed within rotor chamber 320 in accordance with various implementations of the invention. As illustrated, in some implementations of the invention, induction heater 510 is disposed along central axis 250 nearest exhaust opening 114 and downstream from rotors 220. This placement of induction heater 510 within rotor chamber 320 may avoid any unnecessary heating of rotors 220. In some implementations of the invention, induction heater 510 may be placed in between various rotors 220 or upstream from rotors 220 as would be appreciated. In some implementations of the invention, induction heater 510 may displace one or more rotors 220 within rotor chamber 320. In some implementations of the invention, induction heater 510 may be additive to rotors 220 within rotor chamber 320. In some implementations of the invention, induction heater 510 is disposed along central axis 250 in a region not otherwise circumferentially surrounded by electromagnetic stators.

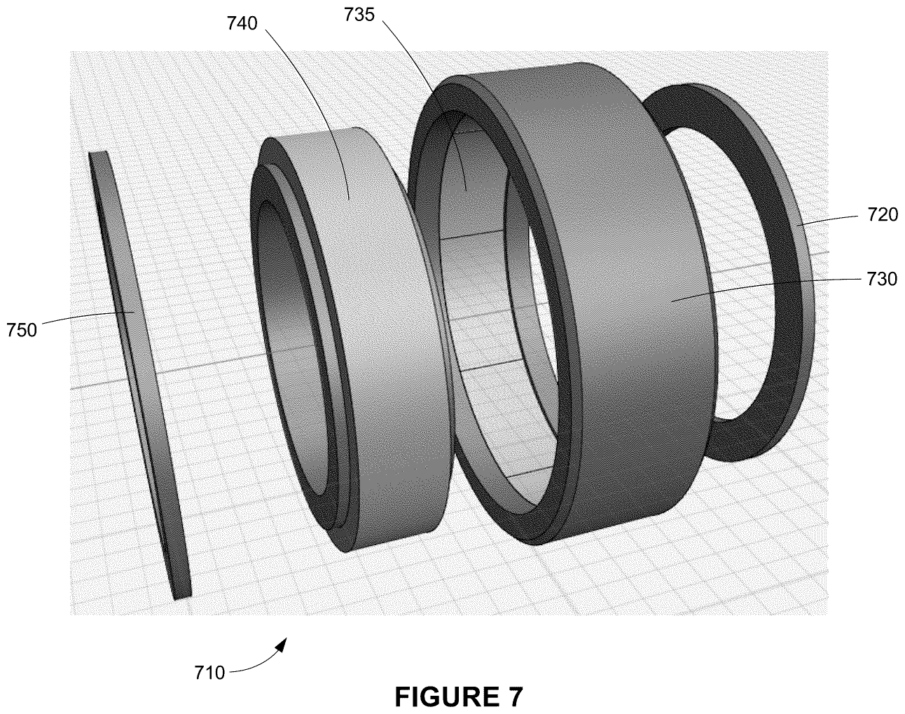

FIG. 7 illustrates an exploded view of a magnetic bearing in accordance with various implementations of the invention. Various implementations of the invention may employ bearings as described herein. For example, shaft 240 may be supported by and turn on bearings within rotor chamber 320; or rotors 220 may be rotatably affixed, via bearings, to shaft 240; or rotor blades 410 may be rotatably affixed, via bearings, to rotor housing 430; etc. In any of these implementations of the invention, such bearings may comprise a magnetic bearing 710. As would be appreciated, magnetic bearings support a load using magnetic levitation, employing magnetic forces to avoid physical contact between bearing surfaces. As such, magnetic bearings are able to levitate a rotating shaft (or other rotating components) and permit relative rotational motion with very little friction and virtually no mechanical wear.

As illustrated in FIG. 7, magnetic bearing 710 primarily comprises an outer bearing ring 730 having an inner surface 735 formed, at least in part, of electromagnetically-conductive material 735 and an inner bearing ring 740 formed, at least in part, of magnetic material. When assembled, inner bearing ring 740 is concentrically and rotatably disposed within a hollow formed by outer bearing ring 730 and positionally maintained there by supports 720, 750. Magnetic fields from the magnetic material of inner bearing ring 740 and electromagnetic fields generated by a controller (not otherwise illustrated) and outer bearing ring 730 maintain an air gap between respective surfaces of inner bearing ring 740 and outer bearing ring 730 as would be appreciated.

In some implementations of the invention, the controller maybe used to generate specific electromagnetic signals, not only to maintain the airgap between outer bearing ring 730 and inner bearing ring 740, but also to prevent (or substantially prevent) rotation of outer bearing ring 730 with respect to inner bearing ring 740. In such implementations, the controller may be used to “park” or “lock” magnetic bearing 710 in relatively fixed position.

In some implementations, similar “park” or “lock” features may be accomplished using magnets in addition to the electromagnetic materials on outer bearing ring 730 such that when the electromagnetic fields of the electromagnetic materials are turned off, the additional magnets interact with the magnetic material of inner bearing ring 740, the two bearing rings become affixed to one another as would be appreciated.

While the invention has been described herein in terms of various implementations, it is not so limited and is limited only by the scope of the following claims, as would be apparent to one skilled in the art. These and other implementations of the invention will become apparent upon consideration of the description provided above and the accompanying figures. In addition, various components and features described with respect to one implementation of the invention may be used in other implementations as would be appreciated.

What is claimed:

1. An electric propulsion engine comprising:
an engine housing forming an outer stator chamber and an inner rotor chamber, the outer stator chamber surrounding and concentric with the inner rotor chamber, the inner rotor chamber having an intake opening and an exhaust opening;
an electromagnetic stator configured within the outer stator chamber;
a plurality of rotors disposed within the inner rotor chamber along a central axis of the inner rotor chamber, each of the plurality of rotors having a plurality of rotor blades configured to rotate around the central axis of the inner rotor chamber thereby compressing a fluid as the fluid passes from the intake opening of the inner rotor chamber toward the exhaust opening of the inner rotor chamber, each of the plurality of rotor blades having a magnetic rotor blade edge responsive to the electromagnetic stator; and
an engine controller configured to provide a control signal to the electromagnetic stator to cause the plurality of rotor blades of at least a portion of the plurality of rotors to rotate around the central axis of the inner rotor chamber thereby producing thrust from the flow of the fluid from the intake opening of the inner rotor chamber toward the exhaust opening of the inner rotor chamber.

2. The electric propulsion engine of claim 1, wherein the engine housing forms the inner rotor chamber so that the inner rotor chamber tapers downward from the intake opening to the exhaust opening.

3. The electric propulsion engine of claim 1, further comprising an induction heater concentric with the central axis of the inner rotor chamber configured to provide additional heat to the fluid flowing through inner rotor chamber, thereby increasing thrust of the electric propulsion engine.

4. The electric propulsion engine of claim 1, wherein the induction heater is disposed proximate to the exhaust opening of the inner rotor chamber.

5. The electric propulsion engine of claim 3, wherein the induction heater comprises:
a hollow metal core configured to be concentric with the central axis of the inner rotor chamber;
a temperature resistance non-magnetic shield configured to outwardly surround the hollow metal core; and
a copper coil configured to outwardly surround the shield, wherein the copper coil is further configured to generate eddy currents in the metal core, thereby heating the metal core, thereby further heating the fluid that flows through the induction heater.

6. The electric propulsion engine of claim 5, wherein the hollow metal core comprises a hollow copper or copper alloy core or other material that generates heat from eddy currents.

7. The electric propulsion engine of claim 1, further comprising:
a shaft located along and concentric with the central axis on the inner rotor chamber; and
a plurality of bearings disposed along the shaft, wherein each of the plurality of bearings is configured to rotatably couple one of the plurality of rotors to the shaft.

8. The electric propulsion engine of claim 7, wherein each of the plurality of rotors further comprises a rotor housing.

9. The electric propulsion engine of claim 8, wherein the plurality of the rotor blades are fixed to the rotor housing, wherein the rotor housing is fixed to a plurality of spokes that collectively couple the rotor housing to one of the plurality of bearings.

10. The electric propulsion engine of claim 1, wherein each of the plurality of rotors further comprises a rotor housing, wherein the rotor housing is configured to mount to the engine housing within the inner rotor chamber, wherein the rotor blades of the rotor are configured to rotate within and relative to the rotor housing and around the central axis of the inner rotor chamber.

11. The electric propulsion engine of claim 1, wherein each of the plurality of rotors and its respective plurality of rotor blades forms an impeller.

12. The electric propulsion engine of claim 1, wherein each of the plurality of rotors and its respective plurality of rotor blades forms a turbine.

13. The electric propulsion engine of claim 1, wherein the engine controller provides control signals to a plurality of electromagnetic stators, each of which causes a corresponding one of the plurality of rotors to rotate around the central axis of the inner rotor chamber.

14. The electric propulsion engine of claim 13, wherein the engine controller provides controls signals that cause some of the plurality of rotors to rotate at different angular rates than others of the plurality of rotors.

15. The electric propulsion engine of claim 13, wherein the engine controller provides controls signals that cause some of the plurality of rotors to rotate in different directions than others of the plurality of rotors.

16. The electric propulsion engine of claim 1, further comprising:
a shaft to which each of the plurality of rotors is affixed; and
at least one magnetic bearing on which the shaft rotates, thereby rotating each of the plurality of rotors.

17. The electric propulsion engine of claim 1, further comprising:
a shaft; and
a plurality of magnetic bearings, each of the plurality of magnetic bearings rotatably affixed between the shaft and a corresponding one of the plurality of rotors upon which the corresponding one of the plurality of rotors rotates, whereby each of the plurality of rotors rotates independently from the shaft and from each other.

18. The electric propulsion engine of claim 1, further comprising:
a plurality of magnetic bearings, each of the plurality of magnetic bearings rotatably affixed between a rotor housing associated with each of the plurality of rotors and the plurality of rotor blades upon which the plurality of rotor blades rotate within the rotor housing.

19. An electric propulsion engine comprising:
an engine housing forming an inner rotor chamber, the inner rotor chamber having an intake opening and an exhaust opening;
an electromagnetic stator configured around an exterior of the engine housing;
a plurality of rotors disposed within the inner rotor chamber along a central axis of the inner rotor chamber, each of the plurality of rotors having a plurality of rotor blades configured to rotate around the central axis of the inner rotor chamber thereby compressing a fluid as the fluid passes from the intake opening of the inner rotor chamber toward the exhaust opening of the inner rotor chamber, each of the plurality of rotor blades having a magnetic rotor blade edge responsive to the electromagnetic stator; and
an engine controller configured to provide a control signal to the electromagnetic stator to cause the plurality of rotor blades of at least a portion of the plurality of rotors to rotate around the central axis of the inner rotor chamber thereby producing thrust from the flow of the fluid from the intake opening of the inner rotor chamber toward the exhaust opening of the inner rotor chamber.
